(19) United States
(12) Patent Application Publication
(10) Pub. No.: US 2024/0059972 A1
(43) Pub. Date: Feb. 22, 2024

(54) SURFACTANT COMPOSITIONS WITH SUPRAMOLECULAR STRUCTURES FOR INDUSTRIAL, HOUSEHOLD, AGRICULTURAL AND OIL/GAS USE

(71) Applicant: BPS JUST ENERGY TECHNOLOGY, LLC, Argyle, TX (US)

(72) Inventors: Jason L. HURST, Roanoke, TX (US); George M. GREEN, Denton, TX (US); Donna Jean SHOTWELL, Eufaula, OK (US); Robert A. GEIGER, Denton, TX (US)

(21) Appl. No.: 18/259,721

(22) PCT Filed: Jan. 5, 2021
(86) PCT No.: PCT/US2021/012212

§ 371 Date: Jun. 28, 2023

(51) Int. Cl. C09K 23/00

(52) U.S. Cl. CPC C09K 23/017

(57) ABSTRACT

Surface-active compositions with supramolecular structures for industrial, household, agricultural, and oil and gas use include a surfactant, a supramolecular host chemical or a supramolecular guest chemical configured to engage in host-guest chemistry with the surfactant, and a solvent. The surface-active compositions optionally can be substantially free of yeast, or protein extracted from yeast. Methods of increasing wettability of a surface and increasing dispersibility in a fluid by using the surface-active compositions are also described.

### FIELD

The present disclosure relates to surfactant compositions having improved surface-active properties. In particular, the surfactant compositions are capable of increasing performance related to reduction in contact angle, wettability, and overall spreadability in typical industry applications.

### BACKGROUND OF THE DISCLOSURE

Over the last few decades there has been growing interest in the surfactant industry to minimize cost and increase performance with a sustainable approach. Normally, these challenges are overcome by synthetic design of new and more efficient surfactants, extraction of naturally occurring biodegradable surfactants, or a combination of surfactants to achieve synergy for a specific application.

Surfactant molecules contain a non-polar (hydrophobic) tail and a polar (hydrophilic) head. All surfactants are grouped according to the charge of their polar head group.

Anionic surfactants are commonly used in electric dishwashing detergents, laundry detergents, and in some shampoos. Cationic surfactants are most frequently utilized as corrosion inhibitors, dispersants, and emulsifiers, as well as fabric softeners and rinse aids for haircare products. Zwitterionic surfactants are used in both hair and skin care. Zwitterionic surfactants tend to boost effects of other surfactants when in solution, as well as alter undesirable properties of other surfactants, such as skin irritation and removal of too much moisture from skin and hair when applied. Nonionic surfactants represent a larger portion of the surfactants used for applications ranging from personal care to industrial uses such as wetting, spreading, and foaming agents. Nonionic surfactants have relatively fewer irritation effects to the skin and eyes and exhibit a wide range of performance properties for use in health care, however, they are not as effective in certain applications.

Most surfactants to date are created by taking a heavily concentrated surfactant or combination of surfactants and diluting them with distilled or reserve osmosis water for a final blended variation, which is applied as a treatment. Even though these techniques have been deemed effective, efficiencies related to product performance and cost, as well as environmental impact, have always been considered top priority while using minimal amounts of costly active ingredients to reduce the overall environmental footprint and the cost.

Accordingly, improved compositions and methods are needed to provide better performing surfactant compositions with less environmental impact.

### SUMMARY OF THE DISCLOSURE

In a first aspect of the disclosure, the invention relates to a surface-active composition including: a surfactant; a sufficient amount of a supramolecular host chemical or a supramolecular guest chemical configured to engage in host-guest chemistry with the surfactant; and a solvent, wherein the surface-active composition is substantially free of yeast. In one embodiment, the surfactant includes one or more of the following: a nonionic surfactant selected from polyoxyethylene methyl-n-alkyl ethers, t-octylphenoxy polyoxyethylene ethers, polyoxyethylene sorbitan esters of fatty acids, fatty alcohol ethoxylates, alkyl phenol ethoxylates, alkyl polyglycosides, cocamide diethanolamine, cocamine monoethanolamine, decyl polyglucose, octaethylene glycol, monododecyl ether, oleyl alcohol, polysorbates, sorbitans, fatty acid alkoxylates, nonylphenyl polyethylene glycol ether, ethylene glycol, and polyoxyalkylene glycol or a combination thereof; an anionic surfactant selected from ammonium lauryl sulfate, sodium laureth sulfate, sodium lauryl sarcosinate, sodium myreth sulfate, sodium pareth sulfate, sodium stearate, sodium lauryl sulfate, olefin sulfonate, ammonium laureth sulfate, 2-acrylamido-2-methylpropane sulfonic acid, alkylbenzene sulfonate, chlorosulfolipids, magnesium laureth sulfate, perfluorobutanesulfonic acid, sodium sulfosuccinate esters, secondary alkane sulphonate, or a combination thereof; a cationic surfactant selected from benzalkonium chloride, carbethopendecinium chloride, didecyldimethylammonium chloride, lauryl methyl gluceth-10 hydroxypropyldimonium chloride, octenidine dihydrochloride, coco benzyldimethylammonium chloride, stearalkonium chloride, tetramethylammonium hydroxide, or a combination thereof; or an amphoteric surfactant selected from ammonioethyl sulfates, ammoniopropyl sulfates, ammoniopropane sulfonates, phosphobetaine, dimethylalkyl phosphineoxides, cocamidopropyl betaine, dipalmitoyl phosphatidylcholine, sodium lauroamphoacetate, lecithin, miltefosine, cocoamidohydroxysultaine, or a combination thereof; or any combination of the foregoing. In another embodiment, the surfactant includes polyether-polymethylsiloxane copolymer; sodium (C₁₀₋₁₆) benzensulfonate and sodium xylene sulphonate; benzenesulfonic acid, C₁₀-C₁₆ alkyl derivatives, and compounds with 2-propanamine; lauramine oxide and dimethyltetradecylamine oxide; a secondary alcohol ethoxylate; a polyether trisiloxane; yucca schidigera extract; isotridecanol ethoxylated; cocoamidopropyl betaine; or a combination thereof. In various embodiments relating to the foregoing, the surfactant is present in an amount of about 10 percent to about 99 percent by weight of the composition. In various other embodiments, related to the foregoing, the surfactant is present in an amount of about 15 percent to about 99 percent by weight of the composition.

In an additional embodiment related to the foregoing embodiments, the supramolecular host chemical or supramolecular guest chemical is present in an amount of about 1 percent to about 90 percent by weight of the composition. In a preferred embodiment, the supramolecular host chemical or supramolecular guest chemical is present in an amount of about 45 percent to about 90 percent by weight of the composition. In various embodiments, the supramolecular host chemical is present and includes a nanostructure having a charge, magnetic properties, or both.

In a further embodiment related to the foregoing embodiments, the solvent includes water. In one embodiment, the solvent is present in an amount of 0.1 percent to about 50 percent by weight of the composition. In another embodiment related to the foregoing embodiments above, the solvent includes a non-aqueous solvent.

In another embodiment, the disclosure relates to a method of preparing the surface-active composition of claim 1, which includes: forming a mixture of the solvent and the surfactant; and adding a sufficient amount of the supramolecular host chemical or the supramolecular guest chemical to form the surface-active composition.

In another aspect of the disclosure, the invention relates to a method of increasing wettability of a surface, which includes: applying a surface-active composition to the surface in an effective wetting amount, the surface-active composition including: a surfactant; a supramolecular host chemical or a supramolecular guest chemical configured to engage in host-guest chemistry with the surfactant; and a solvent.

In another aspect of the disclosure, the invention relates to a method for increasing dispersion in a fluid, which includes: adding a surface-active composition to the fluid in an effective dispersing amount, the surface-active composition including a surfactant; a supramolecular host chemical or a supramolecular guest chemical configured to engage in host-guest chemistry with the surfactant; and a solvent. In a preferred embodiment, the fluid includes water containing a hydrocarbon, and the surface-active composition is substantially free of yeast (or substantially free of protein extracted from yeast).

As to the foregoing aspects, various embodiments are now described. In a preferred embodiment, the surface-active composition is applied by a chemical mixing tank, a sprayer, a chemical batch injection, a chemical continuous injection, or a combination thereof. In another embodiment, the surface includes a plant surface. In a further embodiment, the surface includes a subterranean formation surface, and the surface-active composition is either substantially free of yeast or is substantially free of protein extracted from yeast. In a preferred embodiment, the subterranean formation surface includes a shale formation.

In another embodiment, the surfactant is selected to include: a nonionic surfactant selected from polyoxyethylene methyl-n-alkyl ethers, t-octylphenoxy polyoxyethylene ethers, polyoxyethylene sorbitan esters of fatty acids, fatty alcohol ethoxylates, alkyl phenol ethoxylates, alkyl polyglycosides, cocamide diethanolamine, cocamine monoethanolamine, decyl polyglucose, octaethylene glycol, monododecyl ether, oleyl alcohol, polysorbates, sorbitans, fatty acid alkoxylates, nonylphenyl polyethylene glycol ether, ethylene glycol, and polyoxyalkylene glycol or a combination thereof; an anionic surfactant selected from ammonium lauryl sulfate, sodium laureth sulfate, sodium lauryl sarcosinate, sodium myreth sulfate, sodium pareth sulfate, sodium stearate, sodium lauryl sulfate, olefin sulfonate, ammonium laureth sulfate, 2-acrylamido-2-methylpropane sulfonic acid, alkylbenzene sulfonate, chlorosulfolipids, magnesium laureth sulfate, perfluorobutanesulfonic acid, sodium sulfosuccinate esters, secondary alkane sulphonate, or a combination thereof; a cationic surfactant selected from benzalkonium chloride, carbethopendecinium chloride, didecyldimethylammonium chloride, lauryl methyl gluceth-10 hydroxypropyldimonium chloride, octenidine dihydrochloride, coco benzyldimethylammonium chloride, stearalkonium chloride, tetramethylammonium hydroxide, or a combination thereof; and an amphoteric surfactant selected from ammonioethyl sulfates, ammoniopropyl sulfates, ammoniopropane sulfonates, phosphobetaine, dimethylalkyl phosphineoxides, cocamidopropyl betaine, dipalmitoyl phosphatidylcholine, sodium lauroamphoacetate, lecithin, miltefosine, cocoamidohydroxysultaine, or a combination thereof; or any combination of the foregoing. In yet another embodiment, the surfactant is selected to include polyether-polymethylsiloxane copolymer; sodium (C₁₀₋₁₆) benzensulfonate and sodium xylene sulphonate; benzenesulfonic acid, C₁₀-C₁₆ alkyl derivatives, and compounds with 2-propanamine; lauramine oxide and dimethyltetradecylamine oxide; a secondary alcohol ethoxylate; a polyether trisiloxane; yucca schidigera extract; isotridecanol ethoxylated; cocoamidopropyl betaine; or a combination thereof.

In another embodiment related to the foregoing embodiments, the surfactant is present in an amount of about 10 percent to about 99 percent by weight of the composition. In a preferred embodiment, the surfactant is present in an amount of about 15 percent to about 99 percent by weight of the composition. In yet another embodiment, the supramolecular host chemical or supramolecular guest chemical is present in an amount of about 1 percent to about 90 percent by weight of the composition. In a preferred embodiment, the supramolecular host chemical or supramolecular guest chemical is present in an amount of about 45 percent to about 90 percent by weight of the composition. In further embodiments, the supramolecular host chemical is present and includes a nanostructure having a charge, magnetic properties, or both.

### BRIEF DESCRIPTION OF THE DRAWINGS

The present disclosure is best understood from the following detailed description when read with the accompanying figures.

FIG. 1 is a graph showing the results of the contact angle testing in Example 1 according to aspects of the present disclosure;

FIGS. 2A and 2B illustrate the white precipitate formed in the control compositions of Example 2;

FIGS. 2C and 2D illustrate the clear compositions formed in Example 2 according to aspects of the present disclosure;

FIG. 3 is a graph showing the results of the Draves testing in Example 3 according to aspects of the present disclosure;

FIGS. 4A-4D illustrate increased dispersion of the foulant in the compositions of Example 4 according to aspects of the present disclosure;

FIG. 5 is a graph showing the results of the wettability testing in Example 5 according to aspects of the present disclosure;

FIG. 6 is a graph showing the results of the Draves testing in Example 6 according to aspects of the present disclosure;

FIG. 7 is a graph showing the results of the wettability testing in Example 7 according to aspects of the present disclosure; and

FIG. 8 is a graph showing the results of the foam height testing in Example 8 according to aspects of the present disclosure.

### DETAILED DESCRIPTION OF THE PREFERRED EMBODIMENTS

The present disclosure provides compositions and methods that improve, increase, or enhance the surface-active properties of the surfactants in the compositions. In this way, the surface-active compositions are made more effective, permitting increased desirable surfactant properties, the use of reduced amounts of surfactants to achieve the same result, or both. As used herein, a “surfactant” is a chemical that preferentially adsorbs at an interface, lowering the surface tension or interfacial tension between fluids or between a fluid and a solid. Surfactants encompass a variety of materials that function as emulsifiers, dispersants, oil-wetters, water-wetters, foamers, and defoamers.

In certain embodiments, the surface-active compositions are substantially free of yeast. In other embodiments, the surface-active compositions are substantially free of protein extract derived from yeast. As used herein, “substantially free” means no more than about 1 percent by weight. For example, the surface-active compositions can contain about 0.01 to about 0.9 percent by weight yeast, such as 0.1 to 0.5 percent by weight, of yeast.

In several embodiments, the surface-active compositions provide improved wettability, dispersibility, foamability, spreadability, and stability. In certain embodiments, the compositions provide increased oil-water wettability (e.g., for shale formations in oil and gas applications), increased wettability of a soil-less media (e.g., in agricultural usage during the growth cycle), increased spreadability across hydrophobic (water repelling) surfaces, reduced surface tension, and increased stability in high salinity environments. As further discussed below, the compositions can be used in a variety of applications, including industrial, household, agricultural, and oil and gas applications. In various embodiments, the compositions are applied via conventional methods, such as by a chemical mixing tank, a sprayer, a chemical batch injection or a chemical continuous injection, or using any other available application technique and equipment.

In certain embodiments, the methods described herein use surface-active compositions that are substantially free of yeast. In some embodiments, the surface-active compositions are substantially free of protein extract derived from yeast. For example, the methods of increasing wettability of a surface and/or the methods for increasing dispersion in a fluid described herein may use a surface-active composition that has no more than about 1 percent by weight of yeast.

In several embodiments, the surface-active compositions include (1) a surfactant; (2) a supramolecular host or guest chemical configured to engage in host-guest chemistry with the surfactant, preferably in an amount sufficient to form stable supramolecular structures between the components of the composition; and (3) a solvent, preferably an aqueous solvent. When components (1)-(3) are mixed together, supramolecular structures are formed that have an enhanced synergy that allow increased performance in oil-water wettability, soil-less media wettability, spreadability across hydrophobic surfaces, dispersibility, foamability, and/or stability in high saline environments, or any combination thereof. Such supramolecular structures or assemblies may take the form of, e.g., micelles, liposomes, nanostructures, or nanobubbles.

In some embodiments, the surface-active compositions provide a blend of different surfactants and supramolecular host or guest chemistries that promote synergy and performance of the surfactant compositions. This is achieved by the formation of supramolecular structures that stabilize the surfactant chemistry micelle formation. When a gas/liquid, liquid/liquid, gas/solid or liquid/solid phase are in contact with one another, the molecules at the interface become unbalanced forces. Without being bound by theory, it is believed that the surface-active compositions and methods described herein increase the overall ability of a surfactant to modify the cohesive or excess energy required at the interface to allow one liquid the ability to overcome the contact with another. The combination of these two characteristics expand how the surface-active compositions can be applied without losing efficiency as happens in the manner of a surfactant alone without the synergy of the solvent and supramolecular host or guest chemistries described herein, thereby providing the opportunity for a sustainable approach in the surfactant industry or in specialty chemistry to achieve the same result with less surfactant. Again, without being bound by theory, the formation of supramolecular structures with the surfactant is believed to promote lower interfacial tension and contact angle measurements over conventional mixtures without supramolecular structures.

In various embodiments, the surfactant includes a nonionic, an anionic, a cationic or a zwitterionic surfactant, or a combination thereof. The surfactant is present in any suitable amount but is generally present in the surface-active composition in an amount of about 10 percent to about 99 percent by weight of the surface-active composition, such as about 15 percent to about 99 percent by weight of the surface-active composition. In some embodiments, the surfactant is present in an amount of about 50 percent to about 97 percent, for example 60 percent to about 95 percent, by weight of the surface-active composition.

Nonionic surfactants of homologous structures are composed of alkyl chains that differ in their number of carbon atoms. They typically contain at least one hydrophobic (water-insoluble) alkyl chain and one oxygen-bearing group. Suitable examples of nonionic surfactants include, but are not limited to, polyoxyethylene glycol monoethers, polyoxyethylene methyl-n-alkyl ethers, t-octylphenoxy polyoxyethylene ethers, polyoxyethylene sorbitan esters of fatty acids, fatty alcohol ethoxylates, alkyl phenol ethoxylates, alkyl polyglycosides, cocamide diethanolamine/monoethanolamine (DEA/MEA), decyl polyglucose, octaethylene glycol, monododecyl ether, oleyl alcohol, polysorbates (e.g., Tween® 80), sorbitans, fatty acid alkoxylates, or a combination thereof.

Anionic surfactants contain at least one hydrophobic alkyl chain and a hydrophilic (water-soluble) group carrying a negative charge. Suitable examples of anionic surfactants include, but are not limited to, ammonium lauryl sulfate, sodium laureth sulfate, sodium lauryl sarcosinate, sodium myreth sulfate, sodium pareth sulfate, sodium stearate, sodium lauryl sulfate, olefin sulfonate, ammonium laureth sulfate, 2-acrylamido-2-methylpropane sulfonic acid, alkylbenzene sulfonate, chlorosulfolipids, magnesium laureth sulfate, perfluorobutanesulfonic acid, sodium sulfosuccinate esters, or a combination thereof.

Cationic surfactants contain at least one hydrophobic alkyl chain and a hydrophilic (water-soluble) group carrying a positive charge. Suitable examples of cationic surfactants include, but are not limited to, benzalkonium chloride, carbethopendecinium chloride, didecyldimethylammonium chloride, lauryl methyl gluceth-10 hydroxypropyldimonium chloride, octenidine dihydrochloride, stearalkonium chloride, tetramethylammonium hydroxide, or a combination thereof.

Zwitterionic or amphoteric surfactants can exhibit either cationic or anionic behavior depending on the pH of the environment. Suitable examples of zwitterionic surfactants include, but are not limited to, ammonioethyl sulfates, ammoniopropyl sulfates, ammoniopropane sulfonates, phosphobetaine, dimethylalkyl phosphineoxides, cocamidopropyl betaine, dipalmitoyl phosphatidylcholine, sodium lauroamphoacetate, lecithin, miltefosine, or a combination thereof.

One of ordinary skill in the art will readily recognize that the surfactants described above are merely an exemplary list and that this list is neither exclusive nor limiting of the surface-active compositions and methods described herein, although those listed herein are be preferred surfactants in certain embodiments according to the disclosure.

In selecting suitable supramolecular host or guest chemical(s), (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with a solvent. A preferred solvent includes an aqueous solvent, such as water. Host chemicals may include nanostructures of various elements and compounds, which may have a charge, may have magnetic properties, or both. Suitable supramolecular host chemicals include cavitands, cryptands, rotaxanes, catenanes, or any combination thereof.

Cavitands are container-shaped molecules that can engage in host-guest chemistry with guest molecules of a complementary shape and size. Examples of cavitands include cyclodextrins, calixarenes, pillarrenes, and cucurbiturils. Calixarenes are cyclic oligomers, which may be obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH2]₃N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another but cannot be separated unless covalent bond breakage occurs.

Suitable supramolecular guest chemicals include cyanuric acid, water, and melamine, and are preferably selected from cyanuric acid or melamine, or a combination thereof. Another category of guest chemical includes nanostructures of various elements and compounds, which may have a charge, may have magnetic properties, or both.

The supramolecular host chemical or the supramolecular guest chemical is present in the surface-active composition in any suitable amount but is generally present in the surface-active composition in an amount of about 1 percent to about 90 percent by weight of the surface-active composition. In certain embodiments, the supramolecular host chemical or supramolecular guest chemical, or host and guest chemical combination, is present in an amount of about 1 percent to about 50 percent by weight of the surface-active composition, for example, 10 percent to about 40 percent by weight of the surface-active composition. In another example, the supramolecular host chemical or supramolecular guest chemical, or host and guest chemical combination, is present in an amount of about 45 percent to about 90 percent by weight of the surface-active composition.

Any aqueous based solvent may be used, including for example water or any alcohol. Water is used as a preferred solvent for the different components of the surface-active composition. Water (or other polar solvent) is present in any suitable amount but is generally present in the surface-active composition in an amount of about 0.1 percent to about 50 percent by weight of the surface-active composition. In certain embodiments, the polar solvent, such as water, is present in an amount of about 1 percent to about 45 percent by weight of the surface-active composition, for example, 20 percent to about 40 percent by weight of the surface-active composition. In various embodiments, the solvent partially dissolves one more components of the surface-active composition. In some embodiments, the solvent is selected to at least substantially dissolve (e.g., dissolve at least 90 percent, preferably at least about 95 percent, and more preferably at least about 99 percent or 99.9 percent, of all the components) or completely dissolve all of the components of the surface-active composition.

Non-aqueous solvents may also be used, although aqueous solvents are preferred. In some embodiments, the non-aqueous solvent includes an oil-based carrier such as a mineral, coconut, or vegetable oil, or a blend thereof.

The order of addition of the components of the surface-active composition can be important to obtain stable supramolecular structures or assemblies in the final mixture. The order of addition is typically: (1) water, (2) surfactant, and (3) supramolecular host or guest chemical. Once the first two components are fully mixed, the supramolecular host or guest chemical is added to the mixture and allowed to mix thoroughly with the other initial components.

### Reduction of Surface Tension and Interfacial Tension

Surface tension is the property of a liquid that allows it to resist an external force, due to the cohesive nature of its molecules. Interfacial tension is similar to surface tension in that cohesive forces are involved, but the main forces in interfacial tension are adhesive forces between the liquid phase of one substance and either a solid, liquid, or gas phase of another substance. Surfactants lower surface tension and interfacial tension by adsorbing to the surface or interface. In the presence of a water-air or water-oil interface, a surfactant aligns itself at the interface so that its hydrophilic component is in the water and its hydrophobic component is in the other phase. The presence of the surfactant disrupts the cohesive forces between water molecules at the interface and reduces the surface tension or the interfacial tension.

Wettability is defined as the attraction of a liquid phase to a solid surface, and it is typically quantified using a contact angle with the solid phase. Lower surface tension and a low contact angle provide better spreading of a liquid over a surface and increased wettability of the surface, which can permit reduced use of the material while achieving the same or similar effects due to increased contact with the more wettable material. In contrast, higher surface tension and a high contact angle are less favorable to the spreading of a liquid over a surface and provide decreased wettability of the surface. Surfactants are commonly used to improve the wetting of an aqueous solution on a hydrophobic surface.

Surface tension also affects dispersibility of one substance in another substance. A high surface tension has a negative effect on dispersibility, as contact between similar particles is preferred in this situation. Surfactants can act as dispersants, and when added to a suspension of solid or liquid particles in a liquid (such as a colloid or emulsion), can improve the separation of the particles and prevent their settling or clumping.

Advantageously, the surface-active compositions disclosed herein may be used in personal care products (e.g., soaps, specialty soaps, liquid hand soaps, shampoos, conditioners, shower gels, dermatology and acne care products), household products (e.g., dry and liquid laundry detergents, dish soaps, dishwasher detergents, toilet bowl cleaners, upholstery cleaners, glass cleaners, general purpose cleaners, fabric softeners), hard surface cleaners (e.g., floor cleaners, metal cleaners, automobile and other vehicle cleaners), pet care products (e.g., shampoos), and cleaning products in general. The surface-active compositions may also be used in industrial applications as lubricants, in emulsion polymerization, in textile processing, as mining flocculates, in petroleum recovery, as dispersants for pigments, as wetting or leveling agents in paints and printing inks, as wetting agents for household and agricultural chemicals and pesticides, and in wastewater treatment and collection systems. The surface-active compositions can also be used as dispersants after oil spills. The disclosure herein is not limited to the above applications, although in various embodiments these applications described herein may be preferred applications for the surfactant compositions described herein.

In various embodiments, the surface-active compositions are used in an agricultural spray (or other application technique) to lower the surface tension of an applied fluid so that the applied drops adhere better on a plant surface. The surface-active compositions also allow sprayed drops to spread more widely and rapidly, resulting in an evenly wetted surface. As a result, reduced quantities of the compositions may be used to achieve a similar, the same, or even a superior effect because of the increased wettability and adherence of such compositions to the surface to which they are applied.

In some embodiments, the surface-active compositions are used in different operations relating to oil and gas production. For example, the surface-active compositions may be used in drilling, cement slurries, fracturing, acidization, demulsification, corrosion inhibition, transportation, cleaning, waterflooding, foam and steam flooding, and environmental protection.

The surface-active compositions can be applied in any suitable manner, including by spraying or mixing the surface-active composition in an amount sufficient to reduce interfacial tension between fluids or between a fluid and a solid. In some embodiments, a surface is sprayed at an effective wetting amount of about 0.01 percent to 0.10 percent of the surface-active composition by weight of the surface (e.g., soil) or about 0.01 to 1 gallon of the surface-active composition per 100 square feet of the surface (e.g. countertop or concrete floor) to increase wettability of the surface (e.g., a plant surface or a subterranean formation surface) or added in an effective dispersing amount of about 0.01 percent to 1 percent (about 10 to 10000 ppm) by weight to a material to increase dispersion of one material in a continuous phase of the material.

### Increase in Stability in High Salinity Environments

Oil and gas surfactants have been successfully used for many years to enhance or improve oil recovery in reservoirs having low temperature and low salinity conditions. However, reservoirs which have harsher conditions, i.e., higher salinity or temperatures, or both, can have an overall significantly lower performance related to surfactant product degradation. Most surfactants readily available tend to precipitate or degrade due to the effects of higher temperatures, increased salinity, and particularly the combined effect of both. To date there has been an overwhelming effort to develop and formulate surfactants for oil recovery applications with a greater response to the conditions of higher temperature and salinity.

Advantageously, use of the surface-active compositions described herein in high salinity environments does not degrade the surfactant or cause the surfactant to precipitate. In certain embodiments, the surface-active composition is added to a treatment fluid that is to be introduced into a subterranean formation in an amount of about 500 ppm to 3000 ppm (0.5 to 3 gallons per thousand equivalent). In some embodiments, the treatment fluid is a fracturing fluid, or any fluid that is useful as a well drilling and servicing fluid in drilling, fracturing, sand control, lost circulation control, completion, conformance control, and/or work over.

### Increase in Foamability

The foaming power of surfactants is an important property in some applications, which has particular utility in the fields of body care products, industrial and hospital products, agricultural products, and oil/gas products. Considerable development efforts have been made to increase the foaming power of surfactants for various of these applications depending on the needs. An increase in foam can be measured by the height of the foam. Advantageously, the surface-active compositions described herein are characterized by an improvement in foamability, thereby increasing the foaming with the same amount of surfactant, or allowing the use of lower amounts of surfactant without sacrificing foamability.

The term “about,” as used herein, should generally be understood to refer to both numbers in a range of numerals even if it appears only before the first number in a range (unless not permitted, in which case the presence of the word about should be ignored). Moreover, all numerical ranges herein should be understood to include each whole integer and tenth of an integer within the range.

The following examples are illustrative of the compositions and methods discussed above and are not intended to be limiting.

### Examples

### Example 1: Compositions for Oil/Water Wettability

Several compositions were prepared using the components and quantities listed in Tables 1-3 below.

TABLE 1
COMPOSITIONS 1-4

| | Distilled | | | TETRA | | |
|---|---|---|---|---|---|---|
| | Water | SAS 30ª | QC 080^{b} | 212^{c} | 9N9^{d} | SymMax ™^{e} |
| Composition | (w/w) | (w/w) | (w/w) | (w/w) | (w/w) | (w/w) |
| Composition 1 | 52.5% | — | — | — | 10.0% | 37.5% |
| Composition 1 (Control) | 90.0% | — | — | — | 10.0% | — |
| Composition 2 | 52.5% | 10.0% | — | — | — | 37.5% |
| Composition 2 (Control) | 90.0% | 10.0% | — | — | — | — |
| Composition 3 | 52.5% | — | 10.0% | — | — | 37.5% |
| Composition 3 (Control) | 90.0% | — | 10.0% | — | — | — |
| Composition 4 | 52.5% | — | — | 10.0% | — | 37.5% |
| Composition 4 (Control) | 90.0% | — | — | 10.0% | — | — |

^{a}WeylClean ® SAS 30 - secondary alkane sulphonate commercially available from The WeylChem Group.
^{b}QC 080 - coco benzyldimethylammonium chloride commercially available from Lamberti Group.
^{c}Tetra 212 - cocoamido hydroxysultaine commercially available from Tetraco LLC.
^{d}Vanwet 9N9 -Nonylphenol polyethylene glycol ether commercially available from Univar Solutions.
^{e}SymMAX ™ supramolecular host or guest water mixture commercially available from Shotwell Hydrogenics, LLC or BPS Shotwell.

TABLE 2
BLENDS USED FOR COMPOSITIONS 5-6

| | Blend A | Blend B |
|---|---|---|
| Components | (w/w) | (w/w) |
| Distilled Water | 72.0% | 60.0% |
| Ethylene Glycol^{a} | 2.0% | 10.0% |
| Polyoxyalkylene Glycol^{b} | 1.0% | 5.0% |
| Cocamidopropyl Hydroxysultaine^{c} | 4.0% | 20.0% |
| Isopropyl Alcohol^{d} | 16.0% | — |
| Nonylphenol Polyethylene Glycol Ether^{e} | 5.0% | 5.0% |

^{a}Commercially available from Brenntag.
^{b}Clearbreak PG-595 demulsifier commercially available from Solvay Specialty Polymer.
^{c}Tetra 212 commercially available from Tetraco LLC.
^{d}Commercially available from Brenntag as 99% isopropyl alcohol.
^{e}Vanwet 9N9 commercially available from Univar Solutions.

TABLE 3
COMPOSITIONS 5-6

| | | Composition | | Composition |
|---|---|---|---|---|
| | Composition | 5 (Control) | Composition | 6 (Control) |
| | 5 (w/w) | (w/w) | 6 (w/w) | (w/w) |
| Blend A^{a} | 10.0% | 10.0% | — | — |
| Blend B^{b} | — | — | 10.0% | 10.0% |
| Distilled Water | 52.5% | 90.0% | 52.5% | 90.0% |
| SymMax ™ ^{c} | 37.5% | — | 37.5% | — |

^{a}Table 2
^{b}Table 2
^{c} SymMAX ™ supramolecular host or guest water mixture commercially available from Shotwell Hydrogenics, LLC or BPS Shotwell.

Contact angle was measured using a DataPhysics Optical Contact Angle (OCA) System 25 Pro, with the measurement based on the captive bubble method. Contact angle, 0 (theta), is a quantitative measure of wetting of a solid by a liquid. In this method, 50 mL of a synthetic water source (96K TDS brine of Table 4) was treated at 1 gallon per thousand (GPT) with the surface-active compositions listed in Tables 1 and 3. This solution was poured into a cuvette and heated up to a reservoir temperature of 155° F., which was monitored by a temperature probe. After the temperature stabilized, a Wolfcamp A rock chip was positioned on a stage inside the solution.

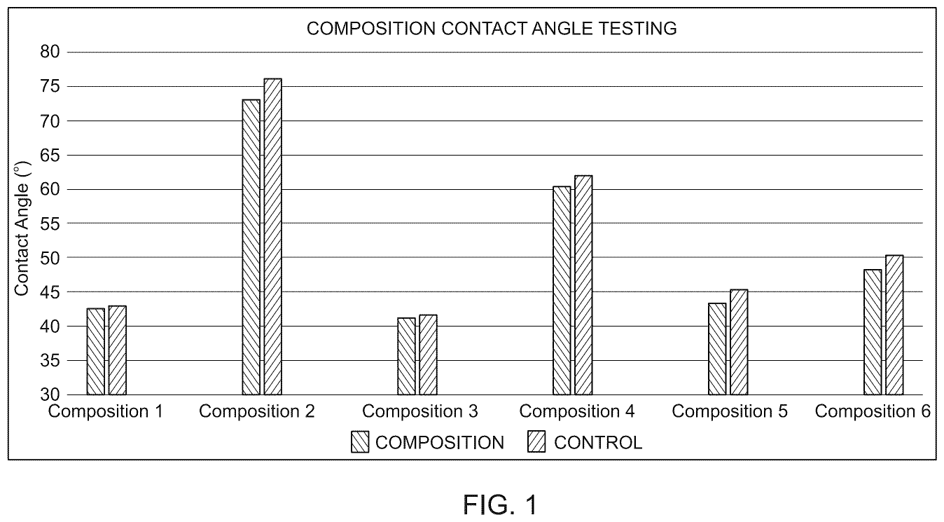

Before the measurement began, the formation rock chips were aged for two weeks in their corresponding oil to restore the initial reservoir state of the rock. Using a 500 μL glass syringe, an oil bubble was dispensed at the tip of a J-shaped needle and was positioned at the bottom-facing part of the chip. The volume of the oil bubble was kept between 0.1-0.2 μL. A hi-speed camera recorded the image, and software calculated the angle of the oil droplet formed on the rock chip. The final measurement was calculated utilizing an average of 10 separate measurements as described. A resulting low contact angle between water and a treated substrate indicated the success a surfactant had on a treated surface. Table 5 provides the results, and FIG. 1 illustrates the results.

TABLE 4
COMPOSITION OF 96K TOTAL DISSOLVED
SOLIDS (TDS) BRINE

| | Percent |
|---|---|
| Component | (w/w) |
| Sodium Chloride | 8.72% |
| Calcium Chloride | 0.48% |
| Sodium Bicarbonate | 0.19% |
| Magnesium Chloride | 0.14% |
| Sodium Sulfate | 0.08% |
| Deionized Water | 90.4% |

TABLE 5
RESULTS OF CONTACT ANGLE TESTING

Contact Angle (°)

| Composition | Composition | Control |
|---|---|---|
| Composition 1 | 42.64 | 42.94 |
| Composition 2 | 72.98 | 76.11 |
| Composition 3 | 41.28 | 41.71 |
| Composition 4 | 60.39 | 62.01 |
| Composition 5 | 43.39 | 45.31 |
| Composition 6 | 48.30 | 50.34 |

As seen in FIG. 1, there was a positive impact on the contact angle with the surface-active compositions exhibiting supramolecular host chemistry. The reduction in contact angle, interfacial tension, and surface tension can aid in alteration of a shale formation's ability to become water wet with compositions of the disclosure. This along with cohesive and adhesive forces appears to result in a more ideal formation face by allowing free hydrocarbons to flow from the reservoir at a more defined pace when compared to a non-treated oil-wet surface, which will relate to a greater attraction of the oil to the formation face.

### Example 2: Compositions for Stability to Salinity

Several compositions were prepared using the components and quantities listed in Tables 4-6 below.

TABLE 6
BLENDS USED FOR COMPOSITIONS 7-10

| | Blend A | Blend B | | |
|---|---|---|---|---|
| | (Control) | (Control) | Blend C | Blend D |
| | (w/w) | (w/w) | (w/w) | (w/w) |
| Distilled Water | 72.0% | 60.0% | 34.50% | 22.5% |
| Ethylene Glycol^{a} | 2.0% | 10.0% | 2.0% | 10.0% |
| Polyoxyalkylene Glycol^{b} | 1.0% | 5.0% | 1.0% | 5.0% |
| Cocamidopropyl | 4.0% | 20.0% | 4.0% | 20.0% |
| Hydroxysultaine ^{c} | | | | |
| Isopropyl Alcohol^{d} | 16.0% | — | 16.0% | — |
| Nonylphenol | 5.0% | 5.0% | 5.0% | 5.0% |
| Polyethylene | | | | |
| Glycol Ether^{e} | | | | |
| SymMAX ™ ^{f} | — | — | 37.5% | 37.5% |

^{a}Commercially available from Brenntag.
^{b}Clearbreak PG-595 demulsifier commercially available from Solvay Specialty Polymer.
^{c} Tetra 212 commercially available from Tetraco LLC.
^{d}Commercially available from Brenntag as 99% isopropyl alcohol.
^{e}Vanwet 9N9 commercially available from Univar Solutions.
^{f} SymMAX ™ supramolecular host or guest water mixture commercially available from Shotwell Hydrogenics, LLC or BPS Shotwell.

TABLE 7
COMPOSITIONS 7-10

| | Composition | | | | | | | |
|---|---|---|---|---|---|---|---|---|
| Component | 7a | 7b | 8a | 8b | 9c | 9d | 10c | 10d |
| Blend A (Control)ª | 0.10 g | 0.20 g | — | — | — | — | — | — |
| Blend B (Control)^{b} | — | — | 0.10 g | 0.20 g | — | — | — | — |
| Blend C^{c} | — | — | — | — | 0.10 g | 0.20 g | — | — |
| Blend D^{d} | — | — | — | — | — | — | 0.10 g | 0.20 g |
| 96K TDS Brine^{e} | 100 g | 100 g | 100 g | 100 g | 100 g | 100 g | 100 g | 100 g |

^{a}Blend A - Table 6
^{b}Blend B - Table 6
^{c}Blend C - Table 6
^{d}Blend D - Table 6
^{e}96K TDS Brine - Table 4

In this example, surface-active compositions were prepared with and without the supramolecular chemistry. Separate 100 gram samples of a synthetic water source (96,000 TDS Brine, Table 4) were treated at 0.1 g and 0.2 g with the surface-active compositions listed in Table 7. Next, a 20 mL aliquot was placed in scintillation vials labeled as Control A and B at 1 GPT and 2 GPT equivalents, respectively. A second corresponding set of scintillation vials were labeled as Composition C and D at 1 GPT and 2 GPT equivalents, respectively. The scintillation vials were placed in a laboratory oven at 180° F. for 24 hours.

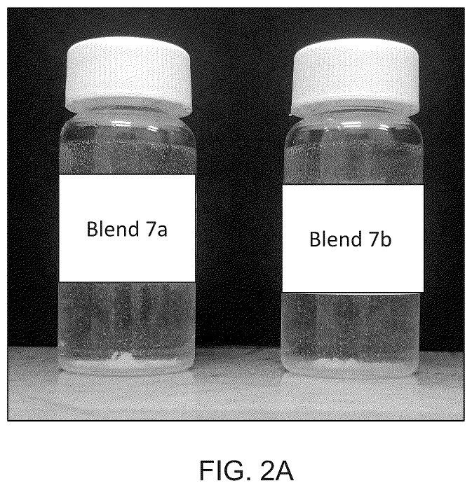

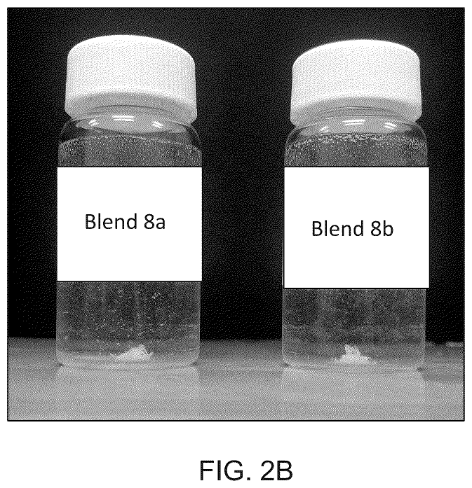

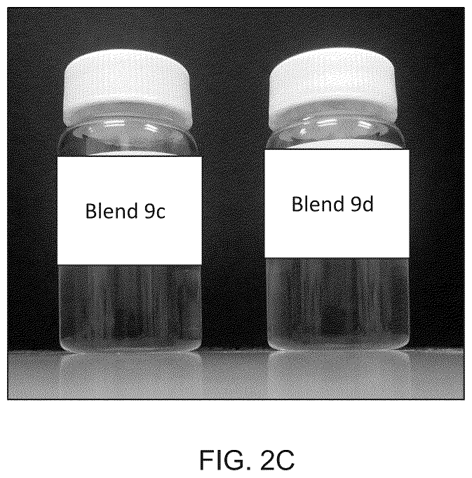

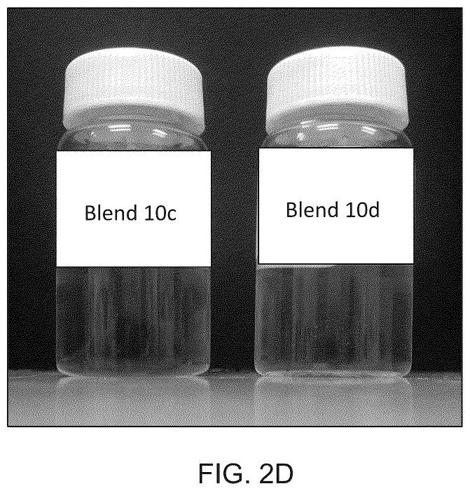

After 24 hours, the samples containing SymMAX™ supramolecular host or guest water mixture were crystal clear, as seen in FIGS. 2C and 2D, while the samples that did not contain supramolecular structures had small amounts of white precipitate as seen in FIGS. 2A and 2B. The tested surface-active compositions with the supramolecular structures were shown to provide additional stability in brine water measuring TDS of 96,000 when placed in the oven at 180° F. for 24 hours.

### Example 3: Compositions for Draves Wettability

The compositions shown in Table 8 were prepared.

TABLE 8
COMPOSITION 11

| | | BREAK- | |
|---|---|---|---|
| | Distilled | THRU ® | |
| | Water | S 301^{a} | SymMax ™ ^{b} |
| | (w/w) | (w/w) | (w/w) |
| Composition 11 | — | 62.5% | 37.5% |
| Composition 11 (Control) | 37.5% | 62.5% | — |
| BREAK-THRU ® S 301^{a} | — | 100% | — |

^{a}Polyether-polymethylsiloxane copolymer commercially available from Evonik Nutrition & Care GmbH.
^{b} SymMAX ™ supramolecular host or guest water mixture commercially available from Shotwell Hydrogenics, LLC or BPS Shotwell.

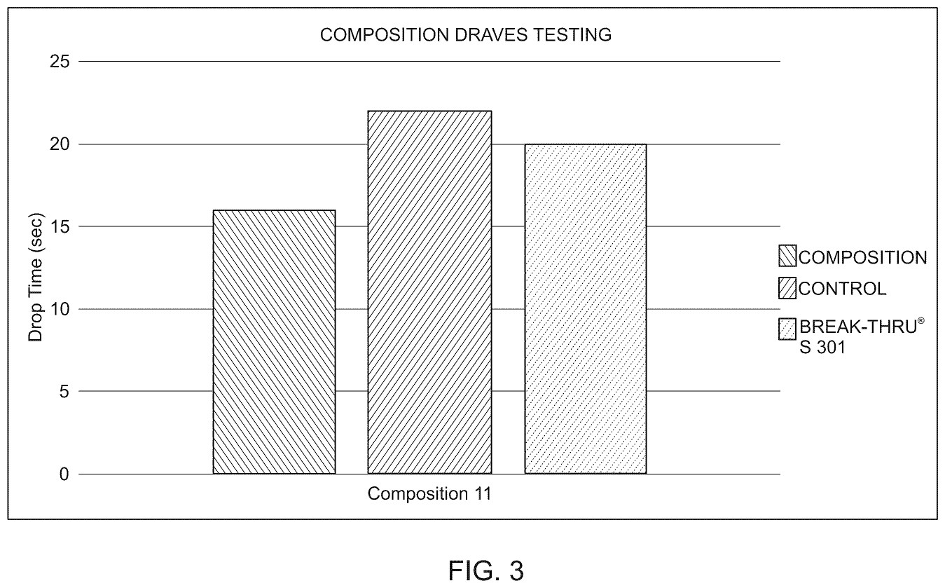

In this example, different surfactants were prepared with and without supramolecular structures. Per ASTM D2281-10 (Standard Test Method for Evaluation of Wetting Agents) a weighted cotton test skein was dropped into a tall, graduated cylinder containing 0.05% (w/w) of the surface-active composition in water. The time required for the cotton skein to sink to the bottom of the cylinder relates to the ability a surfactant has on wetting the surface of the skein. A good wetting agent will have a time of less than 30 seconds. Table 9 provides the results, and FIG. 3 illustrates the results.

TABLE 9
RESULTS OF DRAVES TESTING

| | Drop Time (seconds) |
|---|---|
| Composition 11 | 16 |
| Composition 11 (Control) | 22 |
| BREAK-THRU ® S 301^{a} | 20 |

^{a}Polyether-polymethylsiloxane copolymer commercially available from Evonik Nutrition & Care GmbH.

In FIG. 3, composition 11 with supramolecular structure was 27% faster in wetting the skein compared to the control. When compared to the BREAK-THRU® 301 surfactant, the wetting time is 20% faster in wetting the skein with 37.5% less surfactant, showing the impact a surfactant mixed with supramolecular structures had on product performance related to wettability. The reduction in drop time as tested can be directly related to a surfactant's ability to wet a hydrophobic surface.

### Example 4: Compositions for Hot and Cold Flask Test

The compositions shown in Table 10 were prepared.

TABLE 10
COMPOSITIONS 12-15

| | Distilled | | | | | |
|---|---|---|---|---|---|---|
| | Water | D-40^{a} | N-411^{b} | LO^{c} | 15-S-7^{d} | SymMax ™^{e} |
| | (w/w) | (w/w) | (w/w) | (w/w) | (w/w) | (w/w) |
| Composition 12 | 40.0% | — | — | — | 50.0% | 10.0% |
| Composition 12 (Control) | 50.0% | — | — | — | 50.0% | — |
| Composition 13 | 40.0% | 50.0% | — | — | — | 10.0% |
| Composition 13 (Control) | 50.0% | 50.0% | — | — | — | — |
| Composition 14 | 40.0% | — | 50.0% | — | — | 10.0% |
| Composition 14 (Control) | 50.0% | — | 50.0% | — | — | — |
| Composition 15 | 40.0% | — | — | 50.0% | — | 10.0% |
| Composition 15 (Control) | 50.0% | — | — | 50.0% | — | — |

^{a}BIO-SOFT ® D-40 - sodium (C10-16) benzensulfonate and sodium xylene sulphonate (SXS) commercially available from Stepan Company.
^{b}BIO-SOFT ® N-411 - benzenesulfonic acid, C10-C16 alkyl derivatives, and compounds with 2-propanamine commercially available from Stepan Company.
^{c}Ammonyx ® LO - lauramine oxide and dimethyltetradecylamine oxide commercially available from Stepan Company.
^{d}TERGITOL ™ 15-S-7 - secondary alcohol ethoxylate commercially available from The Dow Chemical Company.
^{e}SymMAX ™ supramolecular host or guest water mixture commercially available from Shotwell Hydrogenics, LLC or BPS Shotwell.

In this example, a Hot and Cold Flask Test was used to determine a surfactant's ability to act as a dispersant. Five (5) grams of a produced foulant sample (hydrocarbon-paraffin wax solids) were weighed out and placed into glass bottles. The foulant used had a WAT-wax appearance temperature of 55-65° C. Different surface-active compositions were applied at 1000 ppm in 100 mL of distilled water or 100 μl per 100 mL. The bottles were then placed in a laboratory oven at 80° C. for 45 minutes. After 45 minutes in the oven, the bottles were then removed and placed on an oscillating table for 5 minutes at 150 oscillations per minute. The samples were then allowed to cool for 15 minutes and a visual appearance was noted. The samples were ranked based upon agglomeration of paraffins back to the original form or anti-agglomeration of paraffins via finely dispersed paraffin within the entire 100 mL solution. The treated wax samples were examined for the ability to disperse and suspend hydrocarbons within a solution. The images captured show a difference between the surfactants with and without SymMAX™ supramolecular host or guest water mixture and the ability to improve product performance related to dispersion.

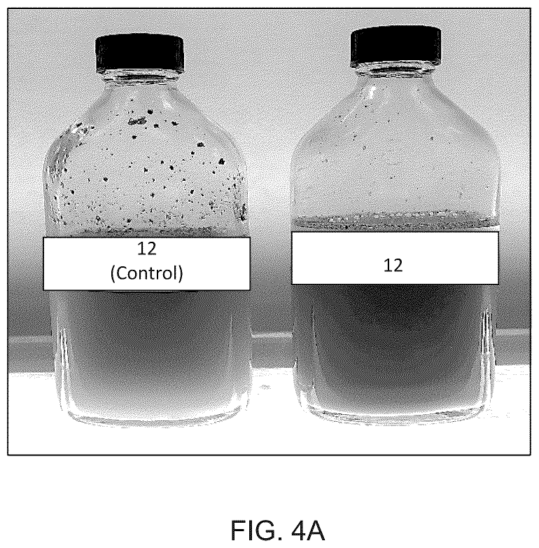

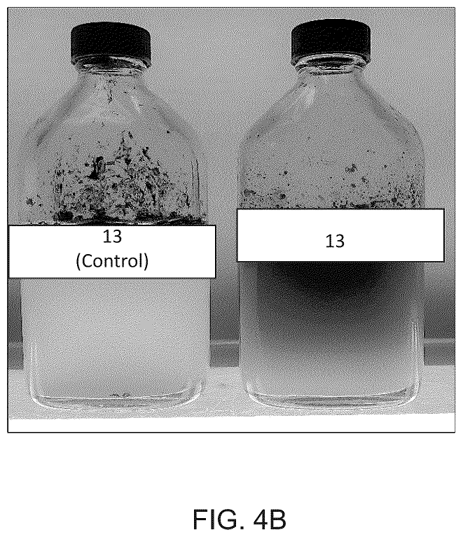

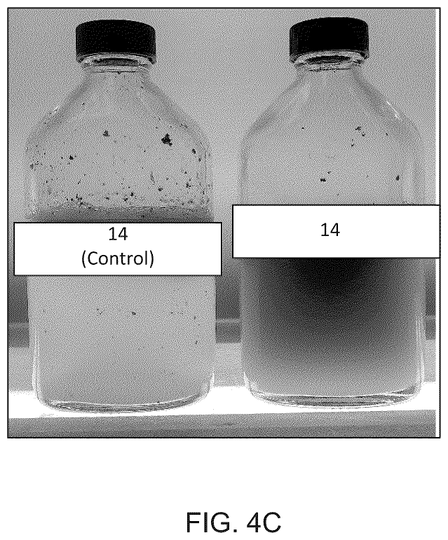

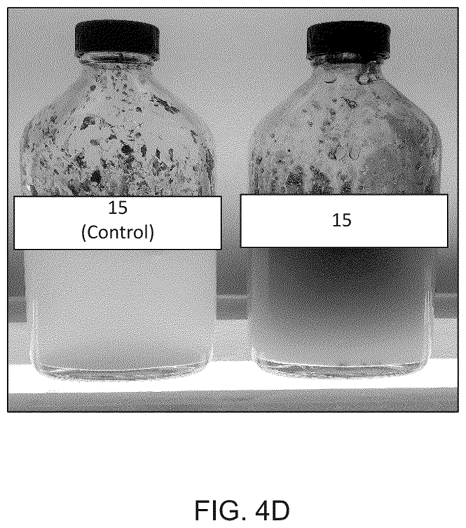

The recorded data shows the impact surfactants mixed with supramolecular structures have on product performance related to a compositions' ability to act as a dispersant. As seen in FIGS. 4A-4D, the finely dispersed foulant was dispersed into the water phase (i.e., the darker the color the more foulant dispersed). The finely dispersed foulant resulting from the compositions herein can help water wet pipelines and prevent paraffin agglomeration, which will reduce the typical problems of plugging of surface equipment in oil and gas operations. The paraffin crystals and metal surfaces are coated by the composition, and it is believed this causes the paraffin particles to repel one another and prevent the re-deposit of paraffin agglomerations, thereby promoting better fluid movement within the production environment.

### Example 5: Compositions for Peat Moss Wettability

The compositions shown in Table 11 were prepared.

TABLE 11
COMPOSITIONS 16-19

| | Distilled | | | | | |
|---|---|---|---|---|---|---|
| | Water | S-200ª | S-301^{b} | S-240^{c} | YEC^{d} | SymMAX ™^{e} |
| | (w/w) | (w/w) | (w/w) | (w/w) | (w/w) | (w/w) |
| Composition 16 | 52.5% | 10.0% | — | — | — | 37.5% |
| Composition 16 (Control) | 90.0% | 10.0% | — | — | — | — |
| Composition 17 | 52.5% | — | 10.0% | — | — | 37.5% |
| Composition 17 (Control) | 90.0% | — | 10.0% | — | — | — |
| Composition 18 | 52.5% | — | — | 10.0% | — | 37.5% |
| Composition 18 (Control) | 90.0% | — | — | 10.0% | — | — |
| Composition 19 | 52.5% | — | — | — | 10.0% | 37.5% |
| Composition 19 (Control) | 90.0% | — | — | — | 10.0% | — |

^{a}BREAK-THRU ® S 200 - concentrated polyether trisiloxane commercially available from Evonik Nutrition & Care GmbH.
^{b}BREAK-THRU ® S 301 - polyether-polymethylsiloxane copolymer commercially available from Evonik Nutrition & Care GmbH.
^{c}BREAK-THRU ® S 240 - polyether trisiloxane commercially available from Evonik Nutrition & Care GmbH.
^{d}Yucca Schidigera Extract commercially available from Desert King.
^{e}SymMAX ™ supramolecular host or guest water mixture commercially available from Shotwell Hydrogenics, LLC or BPS Shotwell.

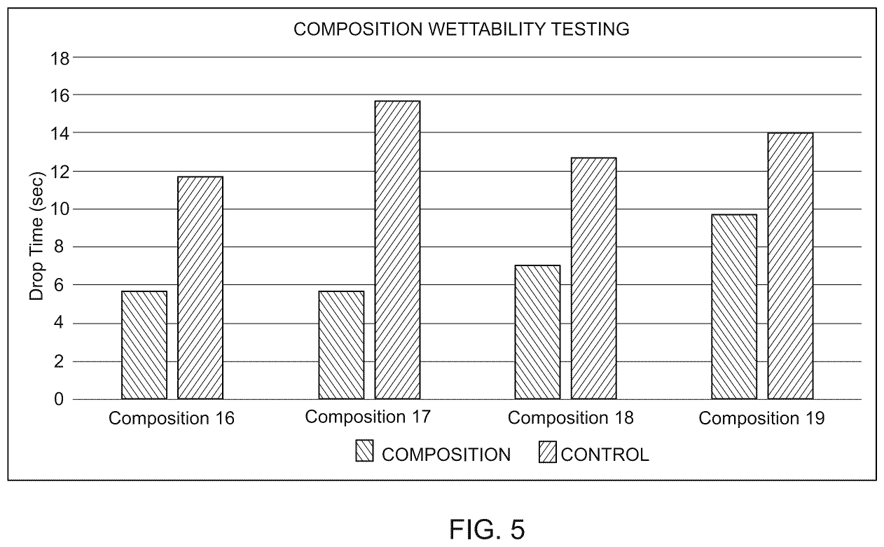

In this example, dried peat moss was dropped into a beaker of water to determine a surfactant's ability to act as a wetting agent. Fifteen (15) grams of dried peat moss (Pro-Mix Professional Grade) were weighed out into a plastic bag. Seven (7) grams of distilled water were added into the plastic bag. Different surface-active compositions were applied with a rate equivalent to 6 fluid oz/yd³ and mixed thoroughly. Five (5) grams of treated peat moss was weighed out three times into separate weigh containers. Each sample was dropped into a beaker with 250 mL of distilled water and timed until complete saturation of the peat moss occurred. Table 12 provides the results, and FIG. 5 illustrates the results.

TABLE 12
RESULTS OF PEAT MOSS WETTABILITY

Drop Time (Seconds)

| | Composition | Control |
|---|---|---|
| Composition 16 | 5.67 | 11.67 |
| Composition 17 | 5.67 | 15.67 |
| Composition 18 | 7.00 | 12.67 |
| Composition 19 | 9.67 | 14.00 |

FIG. 5 shows the impact surfactants mixed with supramolecular structures have on product performance related to a surface-active composition's ability to act as a wetting agent. As seen in FIG. 5, the reduced drop time aids peat moss in becoming wet and reduces the amount of moisture lost to evaporation, further increasing the depth that water or nutrients can penetrate uniformly.

### Example 6: Additional Compositions for Draves Wettability

The compositions shown in Table 13 were prepared.

TABLE 13
COMPOSITIONS 20-22

| | Novel TDA 8^{a} | SYMMAX ™ ^{b} |
|---|---|---|
| | (w/w) | (w/w) |
| Composition 20 | 99% | 1% |
| Composition 21 | 95% | 5% |
| Composition 22 | 90% | 10% |
| Control | 100% | — |

^{a}Novel TDA-8 ethoxylate - isotridecanol ethoxylated commercially available from Sasol Chemicals.
^{b} SymMAX ™ supramolecular host or guest water mixture commercially available from Shotwell Hydrogenics, LLC or BPS Shotwell.

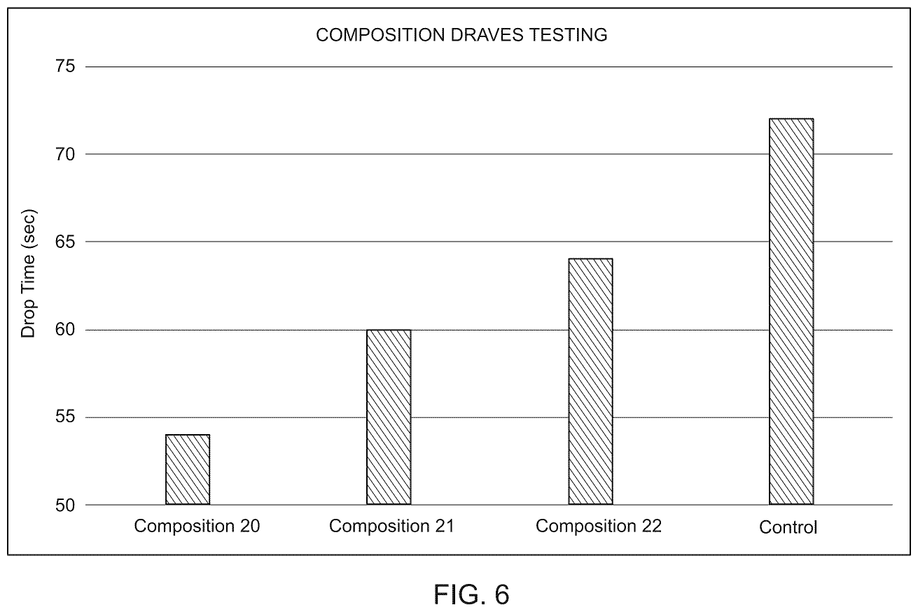

In this example, a surfactant is prepared with and without supramolecular structures. Per ASTM D2281-10 (Standard Test Method for Evaluation of Wetting Agents) a weighted cotton test skein is dropped into a tall, graduated cylinder containing 0.02% (w/w) of the surface-active composition in water. The time required for the cotton skein to sink to the bottom of the cylinder relates to the ability a surfactant has on wetting the surface of the skein. A good wetting agent will have a time of about 60 seconds at 0.02% (w/w). Table 14 provides the results, and FIG. 6 illustrates the results.

TABLE 14
RESULTS OF DRAVES TESTING

| | Drop Time (seconds) |
|---|---|
| Composition 20 | 54 |
| Composition 21 | 60 |
| Composition 22 | 64 |
| Control | 72 |

In FIG. 6, all surface-active compositions with supramolecular structure tested show a performance gain compared to the control. Composition 20 with supramolecular structures was 25% faster in wetting the skein compared to the control, showing the impact a surfactant mixed with supramolecular structures has on product performance related to wettability. The reduction in drop time as tested can be directly related to a surfactant's ability to wet a hydrophobic surface.

### Example 7: Additional Compositions for Peat Moss Wettability

The compositions shown in Table 15 were prepared.

TABLE 15
COMPOSITION 23

| | Distilled Water | Novel TDA 8^{a} | SYMMAX ™ ^{b} |
|---|---|---|---|
| | (w/w) | (w/w) | (w/w) |
| Composition 23 | — | 99% | 1% |
| Control | 1% | 99% | — |
| Novel TDA 8^{a} | — | 100% | — |

^{a}Novel TDA-8 ethoxylate - isotridecanol ethoxylated commercially available from Sasol Chemicals.
^{b} SymMAX ™ supramolecular host or guest water mixture commercially available from Shotwell Hydrogenics, LLC or BPS Shotwell.

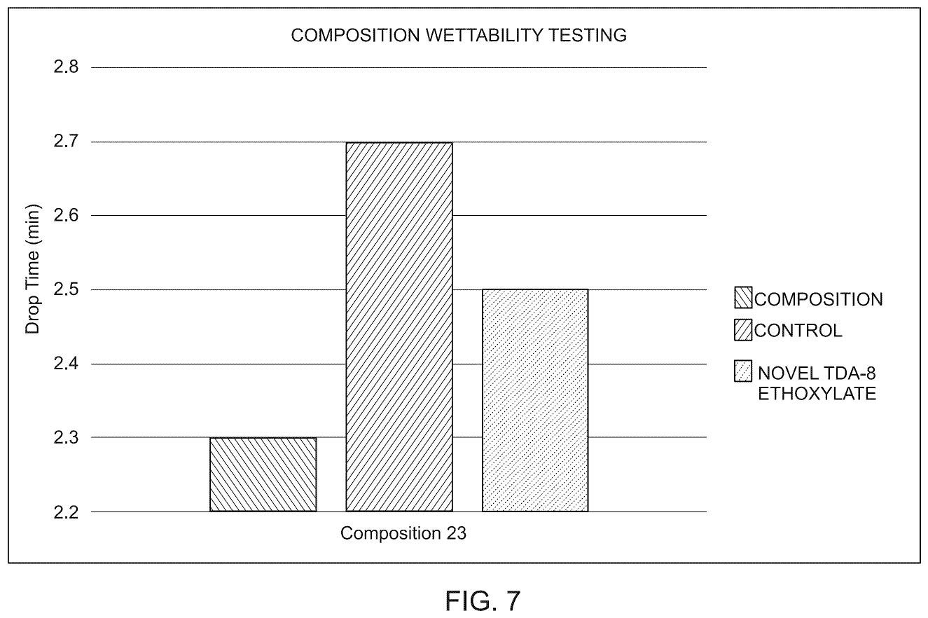

In this example, dried peat moss (Pro-Mix Professional Grade) was dropped into a beaker of water to determine a surfactant's ability to act as a wetting agent. Peat moss was air dried and then sieved using a 2000-micron (#10 mesh) sieve. A 200 mL solution of surfactant in water was prepared at a rate equivalent of 5 fluid oz/yd³ per 2 gallons water and allowed to mix for two minutes. Five (5) grams of dried sieved peat moss was dropped into the surfactant solution and timed until complete saturation of peat moss was achieved. Table 16 provides the results, and FIG. 7 illustrates the results.

TABLE 16
RESULTS OF PEAT MOSS WETTABILITY

| | Drop time (minutes) |
|---|---|
| Composition 23 | 2.3 |
| Control | 2.7 |
| Novel TDA 8^{a} | 2.5 |

^{a}Novel TDA-8 ethoxylate - isotridecanol ethoxylated commercially available from Sasol Chemicals.

As seen in FIG. 7, the composition with supramolecular structure was 15% faster in wetting the skein compared to the control. When compared to Novel TDA-8 ethoxylate, the wetting time is 8% faster in wetting the skein with 1% less surfactant, showing the impact a surfactant mixed with supramolecular structures has on product performance related to wettability. The reduction in drop time as tested can be directly related to a surfactant's ability to wet a hydrophobic surface.

### Example 8: Compositions for Foam Height Test

The compositions shown in Tables 17 and 18 were prepared.

TABLE 17
BLEND USED FOR COMPOSITION 24

| | Distilled Water | AMPHOSOL ® CA | SYMMAX ™ ^{b} |
|---|---|---|---|
| | (w/w) | (w/w) | (w/w) |
| Blend 24 | 60.5% | 10.0% | 29.5% |
| Control | 90.0% | 10.0% | — |

^{a} Cocoamidopropyl betaine commercially available from Stepan Company.
^{b} SymMAX ™ supramolecular host or guest water mixture commercially available from Shotwell Hydrogenics, LLC or BPS Shotwell.

TABLE 18
COMPOSITION 24

| | Composition 24 | Composition 24 (Control) |
|---|---|---|
| Blend 24 | 0.05 g | — |
| Control | — | 0.05 g |
| Distilled Water | 50.0 g | 50.0 g |

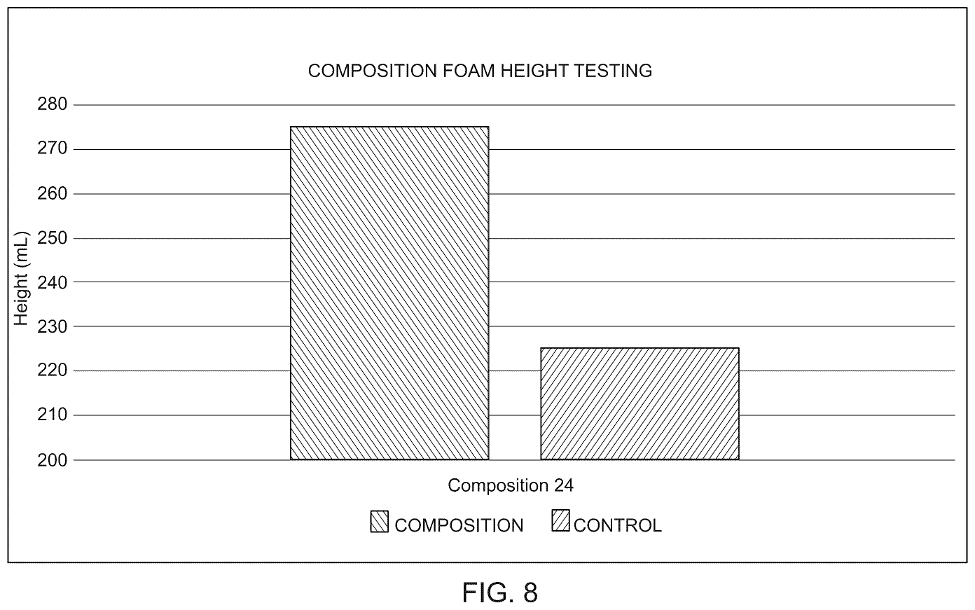

In this example, a commonly used foam generating surfactant was prepared with and without supramolecular structures. Using a 250 mL graduated cylinder, separate 50 gram samples of distilled water were placed in the containers. Using a micropipette, 0.05 g of dilute active was added to the distilled water. A gas dispersion tube, with a 12 mm coarse cylinder, was lowered into the solution and air was supplied through the fluid for a time of 10 seconds. After 10 seconds of air, the foam height was measured in mL as height equivalent. As seen in FIG. 8 and Table 19 below, Composition 24 measured a 20% difference in foam height compared to the control.

TABLE 19
RESULTS OF FOAM HEIGHT TEST

| | Foam Height (mL) |
|---|---|
| Composition 24 | 275 |
| Composition 24 (Control) | 225 |

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

1. A surface-active composition comprising:
a surfactant;
a sufficient amount of a supramolecular host chemical or a supramolecular guest chemical configured to engage in host-guest chemistry with the surfactant; and
a solvent,
wherein the surface-active composition is substantially free of yeast.

2. The surface-active composition of claim 1, wherein the surfactant comprises one or more of the following:
a nonionic surfactant selected from polyoxyethylene methyl-n-alkyl ethers, t-octylphenoxy polyoxyethylene ethers, polyoxyethylene sorbitan esters of fatty acids, fatty alcohol ethoxylates, alkyl phenol ethoxylates, alkyl polyglycosides, cocamide diethanolamine, cocamine monoethanolamine, decyl polyglucose, octaethylene glycol, monododecyl ether, oleyl alcohol, polysorbates, sorbitans, fatty acid alkoxylates, nonylphenyl polyethylene glycol ether, ethylene glycol, and polyoxyalkylene glycol or a combination thereof;
an anionic surfactant selected from ammonium lauryl sulfate, sodium laureth sulfate, sodium lauryl sarcosinate, sodium myreth sulfate, sodium pareth sulfate, sodium stearate, sodium lauryl sulfate, olefin sulfonate, ammonium laureth sulfate, 2-acrylamido-2-methylpropane sulfonic acid, alkylbenzene sulfonate, chlorosulfolipids, magnesium laureth sulfate, perfluorobutanesulfonic acid, sodium sulfosuccinate esters, secondary alkane sulphonate, or a combination thereof;
a cationic surfactant selected from benzalkonium chloride, carbethopendecinium chloride, didecyldimethylammonium chloride, lauryl methyl gluceth-10 hydroxypropyldimonium chloride, octenidine dihydrochloride, coco benzyldimethylammonium chloride, stearalkonium chloride, tetramethylammonium hydroxide, or a combination thereof; or
an amphoteric surfactant selected from ammonioethyl sulfates, ammoniopropyl sulfates, ammoniopropane sulfonates, phosphobetaine, dimethylalkyl phosphineoxides, cocamidopropyl betaine, dipalmitoyl phosphatidylcholine, sodium lauroamphoacetate, lecithin, miltefosine, cocoamidohydroxysultaine, or a combination thereof;
or any combination of the foregoing.

3. The surface-active composition of claim 1, wherein the surfactant comprises polyether-polymethylsiloxane copolymer; sodium (C₁₀₋₁₆) benzensulfonate and sodium xylene sulphonate; benzenesulfonic acid, C₁₀-C₁₆ alkyl derivatives, and compounds with 2-propanamine; lauramine oxide and dimethyltetradecylamine oxide; a secondary alcohol ethoxylate; a polyether trisiloxane; yucca schidigera extract; isotridecanol ethoxylated;
cocoamidopropyl betaine; or a combination thereof.

4. The surface-active composition of claim 1, wherein the surfactant is present in an amount of about 10 percent to about 99 percent by weight of the composition.

5. (canceled)

6. The surface-active composition of claim 1, wherein the supramolecular host chemical or supramolecular guest chemical is present in an amount of about 1 percent to about 90 percent by weight of the composition.

7. (canceled)

8. The surface-active composition of claim 1, wherein the supramolecular host chemical is present and comprises a nanostructure having a charge, magnetic properties, or both.

9. The surface-active composition of claim 1, wherein the solvent comprises water.

10. The surface-active composition of claim 1, wherein the solvent is present in an amount of 0.1 percent to about 50 percent by weight of the composition.

11. The surface-active composition of claim 1, wherein the solvent comprises a non-aqueous solvent.

12. A method of preparing the surface-active composition of claim 1, which comprises:
forming a mixture of the solvent and the surfactant; and
adding a sufficient amount of the supramolecular host chemical or the supramolecular guest chemical to form the surface-active composition.

13. A method of increasing wettability of a surface, which comprises:
applying a surface-active composition to the surface in an effective wetting amount, the surface-active composition comprising:
a surfactant;
a supramolecular host chemical or a supramolecular guest chemical configured to engage in host-guest chemistry with the surfactant; and
a solvent.

14. The method of claim 13, wherein the surface-active composition is applied by a chemical mixing tank, a sprayer, a chemical batch injection, a chemical continuous injection, or a combination thereof.

15. The method of claim 13, wherein the surface comprises a plant surface.

16. The method of claim 13, wherein the surface comprises a subterranean formation surface, and the surface-active composition is substantially free of yeast.

17. The method of claim 16, wherein the subterranean formation surface comprises a shale formation.

18. The method of claim 13, wherein the surfactant is selected to comprise:
a nonionic surfactant selected from polyoxyethylene methyl-n-alkyl ethers, t-octylphenoxy polyoxyethylene ethers, polyoxyethylene sorbitan esters of fatty acids, fatty alcohol ethoxylates, alkyl phenol ethoxylates, alkyl polyglycosides, cocamide diethanolamine, cocamine monoethanolamine, decyl polyglucose, octaethylene glycol, monododecyl ether, oleyl alcohol, polysorbates, sorbitans, fatty acid alkoxylates, nonylphenyl polyethylene glycol ether, ethylene glycol, and polyoxyalkylene glycol or a combination thereof;
an anionic surfactant selected from ammonium lauryl sulfate, sodium laureth sulfate, sodium lauryl sarcosinate, sodium myreth sulfate, sodium pareth sulfate, sodium stearate, sodium lauryl sulfate, olefin sulfonate, ammonium laureth sulfate, 2-acrylamido-2-methylpropane sulfonic acid, alkylbenzene sulfonate, chlorosulfolipids, magnesium laureth sulfate, perfluorobutanesulfonic acid, sodium sulfosuccinate esters, secondary alkane sulphonate, or a combination thereof;
a cationic surfactant selected from benzalkonium chloride, carbethopendecinium chloride, didecyldimethylammonium chloride, lauryl methyl gluceth-10 hydroxypropyldimonium chloride, octenidine dihydrochloride, coco benzyldimethylammonium chloride, stearalkonium chloride, tetramethylammonium hydroxide, or a combination thereof; and
an amphoteric surfactant selected from ammonioethyl sulfates, ammoniopropyl sulfates, ammoniopropane sulfonates, phosphobetaine, dimethylalkyl phosphineoxides, cocamidopropyl betaine, dipalmitoyl phosphatidylcholine, sodium lauroamphoacetate, lecithin, miltefosine, cocoamidohydroxysultaine, or a combination thereof;
or any combination of the foregoing.

19. The method of claim 13, wherein the surfactant is selected to comprise polyether-polymethylsiloxane copolymer; sodium (C₁₀₋₁₆) benzensulfonate and sodium xylene sulphonate; benzenesulfonic acid, C₁₀-C₁₆ alkyl derivatives, and compounds with 2-propanamine; lauramine oxide and dimethyltetradecylamine oxide; a secondary alcohol ethoxylate; a polyether trisiloxane; yucca schidigera extract; isotridecanol ethoxylated; cocoamidopropyl betaine; or a combination thereof.

20. The method of claim 13, wherein the surfactant is present in an amount of about 10 percent to about 99 percent by weight of the composition.

21. (canceled)

22. The method of claim 13, wherein the supramolecular host chemical or supramolecular guest chemical is present in an amount of about 1 percent to about 90 percent by weight of the composition.

23. (canceled)

24. The method of claim 13, wherein the supramolecular host chemical is present and comprises a nanostructure having a charge, magnetic properties, or both.

25. A method for increasing dispersion in a fluid, which comprises:
adding a surface-active composition to the fluid in an effective dispersing amount, the surface-active composition comprising:
a surfactant;
a supramolecular host chemical or a supramolecular guest chemical configured to engage in host-guest chemistry with the surfactant; and
a solvent.

26. The method of claim 25, wherein the fluid comprises water containing a hydrocarbon, and the surface-active composition is substantially free of yeast.

27. The method of claim 25, wherein the surfactant is selected to comprise:
a nonionic surfactant selected from polyoxyethylene methyl-n-alkyl ethers, t-octylphenoxy polyoxyethylene ethers, polyoxyethylene sorbitan esters of fatty acids, fatty alcohol ethoxylates, alkyl phenol ethoxylates, alkyl polyglycosides, cocamide diethanolamine, cocamine monoethanolamine, decyl polyglucose, octaethylene glycol, monododecyl ether, oleyl alcohol, polysorbates, sorbitans, fatty acid alkoxylates, nonylphenyl polyethylene glycol ether, ethylene glycol, and polyoxyalkylene glycol or a combination thereof;
an anionic surfactant selected from ammonium lauryl sulfate, sodium laureth sulfate, sodium lauryl sarcosinate, sodium myreth sulfate, sodium pareth sulfate, sodium stearate, sodium lauryl sulfate, olefin sulfonate, ammonium laureth sulfate, 2-acrylamido-2-methylpropane sulfonic acid, alkylbenzene sulfonate, chlorosulfolipids, magnesium laureth sulfate, perfluorobutanesulfonic acid, sodium sulfosuccinate esters, secondary alkane sulphonate or a combination thereof;
a cationic surfactant selected from benzalkonium chloride, carbethopendecinium chloride, didecyldimethylammonium chloride, lauryl methyl gluceth-10 hydroxypropyldimonium chloride, octenidine dihydrochloride, coco benzyldimethylammonium chloride, stearalkonium chloride, tetramethylammonium hydroxide, or a combination thereof; and
an amphoteric surfactant selected from ammonioethyl sulfates, ammoniopropyl sulfates, ammoniopropane sulfonates, phosphobetaine, dimethylalkyl phosphineoxides, cocamidopropyl betaine, dipalmitoyl phosphatidylcholine, sodium lauroamphoacetate, lecithin, miltefosine, cocoamidohydroxysultaine, or a combination thereof.

28. The method of claim 25, wherein the surfactant is selected to comprise polyether-polymethylsiloxane copolymer; sodium (C₁₀₋₁₆) benzensulfonate and sodium xylene sulphonate; benzenesulfonic acid, C₁₀-C₁₆ alkyl derivatives, and compounds with 2-propanamine; lauramine oxide and dimethyltetradecylamine oxide; a secondary alcohol ethoxylate; a polyether trisiloxane; yucca schidigera extract; isotridecanol ethoxylated; cocoamidopropyl betaine; or a combination thereof.

29. The method of claim 25, wherein the surfactant is present in an amount of about 10 percent to about 99 percent by weight of the composition.

30. (canceled)

31. The method of claim 25, wherein the supramolecular host chemical or supramolecular guest chemical is present in an amount of about 1 percent to about 90 percent by weight of the composition.

32. (canceled)

33. The method of claim 25, wherein the supramolecular host chemical is present and comprises a nanostructure having a charge, magnetic properties, or both.
